(19) United States
(12) Patent Application Publication
(10) Pub. No.: US 2016/0035164 A1
(43) Pub. Date: Feb. 4, 2016

(54) WEARABLE PORTABLE ELECTRONIC DEVICE

(71) Applicant: HON HAI PRECISION INDUSTRY CO., LTD., New Taipei (TW)

(72) Inventor: CHIA-CHING WU, New Taipei (TW)

(21) Appl. No.: 14/680,582

(22) Filed: Apr. 7, 2015

(30) Foreign Application Priority Data
Jul. 29, 2014 (TW) 103125917

(51) Int. Cl. G07C 9/00

(52) U.S. Cl. CPC G07C 9/00309; G07C 2009/00325

(57) ABSTRACT

A wearable portable electronic device includes a main body, a strap connected to the main body, and a transponder. The transponder includes a control module mounted on the main body, an ultrahigh frequency (UHF) transmitter electrically connected to the control module, an UHF antenna coupled to the UHF transmitter, a lower frequency (LF) receiver electrically connected to the control module, and a first LF antenna coupled to the LF receiver. The UHF antenna and the first LF antenna are mounted on the strap. The UHF antenna is mounted on a first portion of the strap. The LF antenna is mounted on a second portion of the strap and the first strap portion is positioned away from the second strap portion.

### FIELD

The subject matter herein generally relates to a wearable portable electronic device, and particularly to a wearable portable electronic device that has a function of passive keyless entry (PKE).

### BACKGROUND

Many modern vehicles are equipped with key fobs with PKE system, and an user can use the key fobs to lock/unlock a vehicle door. The key fob of the PKE system includes a three-axis antenna, and the three-axis antenna includes a magnetic core and a three-axis windings wound on the magnetic core. The three-axis windings includes three mutually orthogonal winds, such that the three-axis winding can receive signals from any direction. Wearable electronic devices are increasing used in recently years. If the antenna can be received in the wearable electronic device, it is convenient for the user to lock/unlock the vehicle door.

### BRIEF DESCRIPTION OF THE DRAWINGS

Implementations of the present technology will now be described, by way of example only, with reference to the attached figures.

FIG. 1 is an isometric view of one embodiment of a wearable portable electronic device.

FIG. 2 is a block diagram of a transponder of the wearable portable electronic device in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising” when utilized, means “including, but not necessarily limited to”; it specifically indicates open-ended inclusion or membership in the so-described combination, group, series and the like.

The present disclosure is described in relation to wearable portable electronic device configured to lock or unlock a door of vehicle.

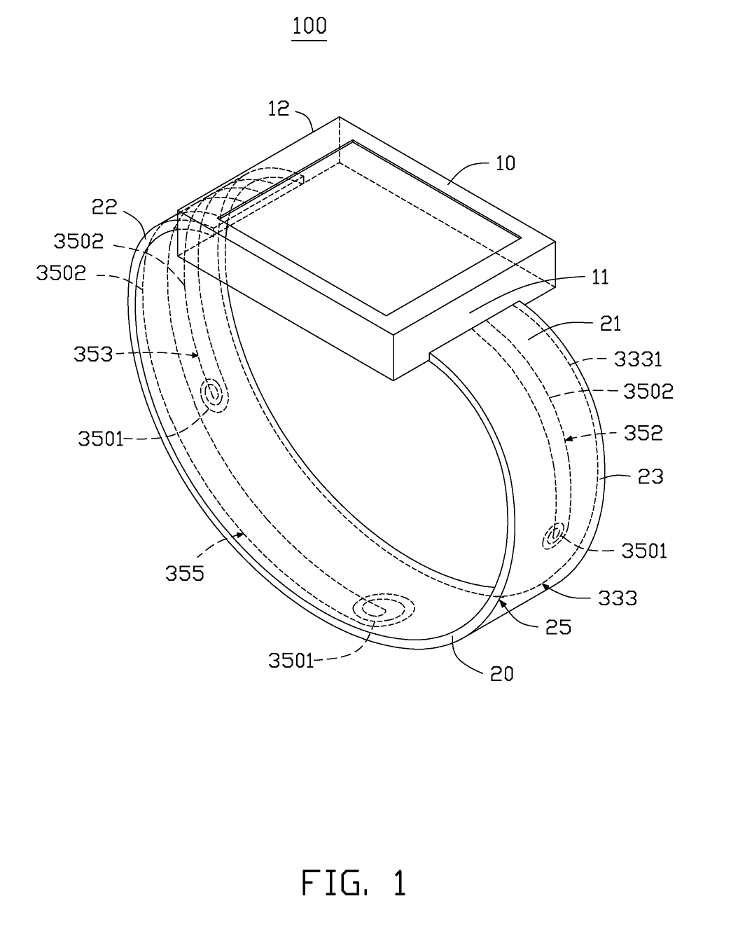

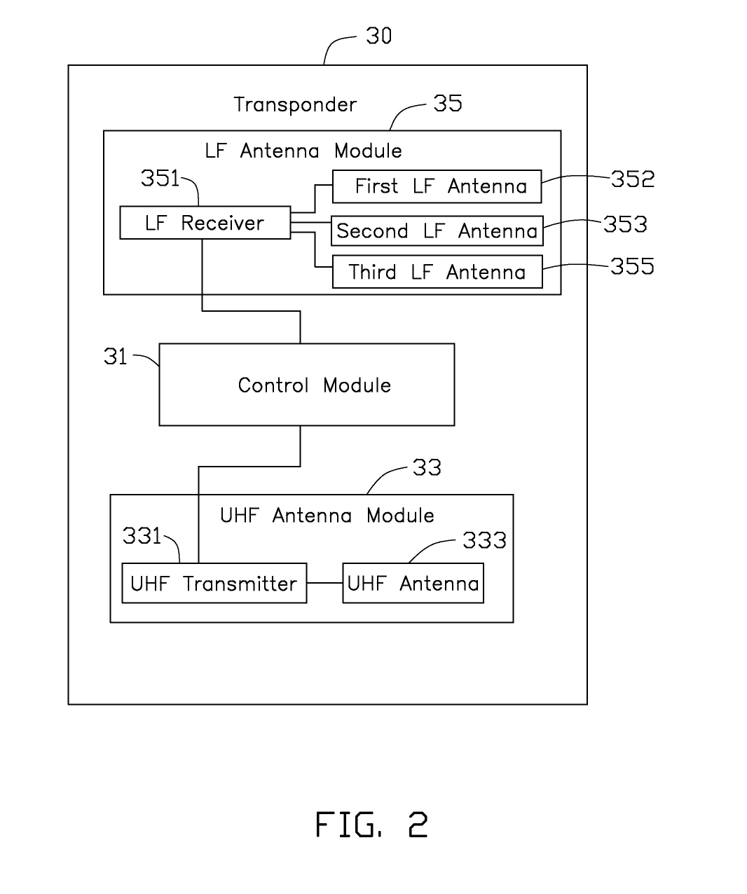

FIG. 1 and FIG. 2 illustrate that a wearable portable electronic device 100 includes a main body 10, a strap 20 connected to the main body 10, and a transponder 30. In at lease one embodiment, the wearable portable electronic device 100 can be a watch. The transponder 30 can be used in conjunction with a base station unit in the vehicle, and the base station unit can be configured to transmit low-frequency signal and receive high-frequency signal. In other embodiments, the wearable portable electronic device 100 can be other wearing devices.

The main body 10 can have a first side portion 11 and a second side portion 12 substantially opposite the first side portion 11. The strap 20 can include a first end 21 and a second end 22 opposite the first end 21. The strap 20 can be bent, and the first strap end 21 can be connected to the first side portion 11 of the main body 10 and the second strap end 22 can be connected to the second side portion 12 of the main body 12. In at least one embodiment, the strap 20 can be a watchband.

FIG. 2 illustrates that the transponder 30 can include a control module 31, an ultrahigh frequency (UHF) antenna module 33, and a low frequency (LF) antenna module 35. In at least one embodiment, the ultrahigh frequency is 315 MHz or 433 MHz, and the low frequency is 125 KHz.

Referring to FIG. 1 and FIG. 2, the control module 31 is illustrated. The control module 31 can be fixed in the main body 10. The UHF antenna module 33 can include an UHF transmitter 331 and an UHF antenna 333. The UHF transmitter 331 can be mounted on the main body 10 and electrically connected to the control module 31. The UHF transmitter 331 can be configured to transmit UHF signals. The UHF antenna 333 can be linear shaped and longer than the strap 20. The UHF antenna 333 can include two joint coupling portions 3331. The two joint coupling portions 3331 can extend to the first side portion 11 and the second side portion 12 of the main body 10 along the edge of the strap 20, and be fixed at the UHF transmitter 331 of the main body 10. The UHF antenna 333 can be configured to send UHF signals transmitted from the UHF transmitter 331. The UHF antenna 333 can be fixed at a first portion 23 of the strap. In at least one embodiment, the UHF antenna 333 can be fixed at an edge of the strap 20.

The LF antenna module 35 can include a LF receiver 351 and three LF antennas coupled to the LF receiver 351. The LF receiver 351 can be fixed at the main body 10 and electrically connected to the control module 31. The three LF antennas can be configured to receive and send the LF signals to the LF receiver 351. The three LF antennas can be fixed at the strap 20, and each LF antenna can be distanced from the UHF antenna 333. Therefore, coupling effect between the three LF antenna and the UHF antenna 333 can be reduced, with minimal interference. In other embodiments, the UHF transmitter 331 and the LF receiver 351 can be fixed at the strap 20.

The three LF antenna can be a first LF antenna 352, a second LF antenna 353, and a third LF antenna 355. The first LF antenna 352 can be mounted on a second portion 24 of the strap 20, and the first strap portion 23 is positioned away from the second strap portion 24. Each LF antenna can include a loop portion 3501 and two connecting portions 3502 extending from two terminals of the loop portion 3501. The loop portions 3501 of the first LF antenna 352, the second LF antenna 353, and the third LF antenna 355 can be helically wound. The two connecting portions 3502 of the first LF antenna 352 can be fixed in one terminal 31 of the strap 20. The loop portion 3501 of the first LF antenna 352 can be parallel to a surface 25 of the strap 20, and the two connecting portions 3502 of the first LF antenna 352 can be coupled to the LF receiver 351. The loop portion 3501 can be wound along a direction perpendicular to the strap 20. The second LF antenna 353 can be fixed at the second end 22 away from the first LF antenna 352, and the two connecting portions 3502 can be coupled to the LF receiver 351. The loop portion 3501 of the second LF antenna 3501 can be parallel to the surface 22 of the strap 20, and the connecting portion 3502 of the second LF antenna 353 can be longer than the connecting portion 3502 of the first LF antenna 352.

The third LF antenna 355 can be fixed at the strap 20. The loop portion 3501 of the third LF antenna 355 can be positioned at a central portion of the strap 20, and positioned between the loop portion 3501 of the first LF antenna 352 and the loop portion 3501 of the second LF antenna 353. The loop portion 3501 of the third LF antenna 355 can be parallel to the surface 22 of the strap 20, and the two connecting portions 3502 of the third LF antenna 355 can be coupled to the LF receiver 351. As the wearable portable electronic device 100 is worn by a user when used to clock or unlock the door of the vehicle, and the wrist of the user is movable, one LF antenna can receive signals from any direction. Therefore, in other embodiments, the LF antenna can be one, two, or more than three. When there is only one LF antenna, the LF antenna can be fixed at any portion of the strap 20. In other embodiments, the UHF antenna 333 are not limited to fixed at the edge of strap 20, as long as the UHF antenna 333 can be a predetermined distance away from the LF antennas.

In use, the wearable portable electronic device 100 can be used to unlock the door of the vehicle. The vehicle can include the base station unit in conjunction with the transponder 30. The base station unit keeps on sending an encoded LF signal, the LF antenna of the transponder 30 can receive and send the LF signal to the LF receiver 351. When the control module 31 verifies the signal received by the LF receiver 351 is valid, it can control the UHF transmitter 331 send UHF signal, and the UHF antenna 333 can send the UHF signal to the base station unit. The base station unit can decode the UHF signal. If the UHF signal can be identified, the door of the vehicle can be unlocked.

The wearable portable electronic device 100 can include the strap 20, and the three LF antennas and the UHF antenna 333 can be mounted in the strap 20. There is no need to wind the LF antennas and the UHF antenna 333 on an iron core, and an space of the three LF antenna can be reduced. Moreover, each of the three LF antennas can receive signal from every direction in space.

The embodiments shown and described above are only examples. Many details are often found in the art such as the other features of a wearable portable electronic device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. A wearable portable electronic device comprising:
a main body, the main body having a first side portion and a second side portion substantially opposite the first side portion;
a strap having a first end and a second end opposite the first end, with the first strap end connected to the main body first side portion and the second strap end connected to the main body second side portion; and
a transponder, the transponder having:
a control module;
an ultrahigh frequency (UHF) transmitter electrically connected to the control module;
a UHF antenna coupled to the UHF transmitter;
a lower frequency (LF) receiver electrically connected to the control module; and
a first LF antenna coupled to the LF receiver;
wherein, the control module is mounted on the main body;
wherein, the UHF antenna is mounted on a first portion of the strap; and
wherein, the LF antenna is mounted on a second portion of the strap and the first strap portion is positioned away from the second strap portion.

2. The wearable portable electronic device of claim 1,
wherein, when a LF signal is received by the LF antenna, the LF signal is sent to the LF receiver and forwarded to the control module for verification; and
wherein, when the LF signal is verified by the control module, the control module controls the UHF transmitter to transmit a UHF signal from the UHF antenna.

3. The wearable portable electronic device of claim 1, wherein the first LF comprises a loop portion, and the loop portion is parallel to a surface of the strap and wound along a direction perpendicular to the surface of the strap.

4. The wearable portable electronic device of claim 1,
wherein the UHF antenna is positioned at an edge of the strap and includes two joint coupling portions; and
wherein the two joint coupling portions extend to the first side portion and the second side portion of the main body along the edge of the strap and coupled to the UHF transmitter.

5. The wearable portable electronic device of claim 4, wherein the UHF antenna is longer than the strap.

6. The wearable portable electronic device of claim 1,
wherein the strap includes two terminals fixed at the two side portions of the main body;
wherein the first LF antenna further includes two connecting portions extending from the loop portion; and
wherein the two connecting portions are mounted at the first end of the strap and coupled to the LF receiver.

7. The wearable portable electronic device of claim 6,
wherein the transponder further comprises a second LF antenna coupled to the LF receiver, and the second LF antenna comprises a loop portion and two connecting portions extending from the loop portion;
wherein the second LF antenna connecting portions are mounted at the second end the strap and coupled to the LF receiver;
wherein the loop portion of the second LF antenna is parallel to the surface of the strap, and the second LF antenna connecting portion is longer than the first LF antenna connecting portion; and
wherein the second LF antenna is distanced from the UHF antenna.

8. The wearable portable electronic device of claim 1,
wherein the transponder further includes a third LF antenna coupled to the LF receiver, and the third LF antenna includes a loop portion and two connecting portions extending from the loop portion;
wherein the third LF antenna loop portion is fixed at a central portion of the strap, and the connecting portions are fixed at the second end of the strap and coupled to the LF receiver;
wherein the loop portion of the third LF antenna is parallel to the surface of the strap, and the third LF antenna connecting portion positioned between the first LF antenna loop portion and the second LF antenna loop portion; and
wherein the third LF antenna is distanced from the UHF antenna.

9. The wearable portable electronic device of claim 1, wherein the wearable portable electronic device is a watch.

10. The wearable portable electronic device of claim 9, wherein the scarp is a watchband.

11. The wearable portable electronic device of claim 1, wherein the transponder is used in conjunction with a base station unit in vehicle.
